(19) United States
(12) Patent Application Publication
(10) Pub. No.: US 2009/0037883 A1
(43) Pub. Date: Feb. 5, 2009

(54) TESTING FRAMEWORK TO HIGHLIGHT FUNCTIONALITY COMPONENT CHANGES

(75) Inventors: Benjamin R. Garbers, Onalaska, WI (US); Duane D. Kirkland, Maple Grove, MN (US); Dale A. Peterson, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/832,062

(22) Filed: Aug. 1, 2007

(51) Int. Cl. G06F 9/44

(52) U.S. Cl. 717/125

(57) ABSTRACT

A computer program product stored on machine-readable media, the product including machine executable instructions for tracking a defect during development of a software work product, the computer program product including instructions for displaying the defect; identifying a component of the work product including the defect; displaying information related to the defect; and receiving input related to testing of the defect to update tracking information.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to the field of software development and particularly to tracking defects during software development.

2. Description of the Related Art

Modern software or computer programs can be complicated particularly when the software includes a graphical user interface (GUI). In order to help simplify writing the software, various software components are used. The various software components generally interact with each other in some way. Each interaction provides an opportunity for the software to fail. When the software fails, it is referred to as a “defect.” When first written, complicated software can have many defects. Testing complicated software can also be complicated.

After a software developer writes a computer program, it is generally sent to a software tester for testing. The software tester usually writes a test plan. The software tester then can test the computer program in accordance with the test plan. Any defects discovered during testing are noted and sent to the software developer for correction. The software developer will correct the defects (i.e., produce a “fix”) and resubmit the computer program back to the software tester for more testing. Discovery of defects by the software tester and correction by the software developer can be an iterative process. The iterative process can also be complicated and have many opportunities for confusion when testing complicated software.

With Rational Function Tester available from IBM Corporation of Armonk, N.Y., the software tester can create automated test cases for testing the GUI. With Rational Function Tester, the software tester can define test cases and create code that will result into a number of automated test cases. However, Rational Function Tester does not indicate where a fix was created in the computer program, so it can be inefficient to test the fixes if the software developer does not know which component contains the fix. Using software to write a test plan can also be complicated when there are many defects to be tested.

Rational Test Manager also available from IBM Corporation allows a software tester to create the test plan. Using Rational Test Manager, the software tester can manually test the computer program to determine whether a fix worked or not. The software tester needs to be alerted as to where the fixes need to be tested. Presently, the software tester has to track the defects and fixes separately from the Rational Test Manager. Use of the Rational Test Manager and separate tracking of the defects and fixes requires the software tester to switch back and forth between two applications. Toggling between the two applications requires additional time and can also add to inefficiency and cause mistakes.

What is needed is an integrated application to track defects and fixes during development and testing of computer programs.

### SUMMARY OF THE INVENTION

The shortcomings of the prior art are overcome and additional advantages are provided through the provision of a computer program product stored on machine-readable media, the product including machine executable instructions for tracking a defect during development of a software work product, the computer program product including instructions for displaying the defect; identifying a component of the work product including the defect; displaying information related to the defect; and receiving input related to testing of the defect to update tracking information.

Further disclosed is a computer program product stored on machine-readable media, the product including machine executable instructions for incorporation into another application as supplemental program code and for tracking a defect during development of a software work product, the computer program product including instructions for displaying the defect in a listing; identifying a component of the work product including the defect by at least one of highlighting, font color changing, and flashing; displaying information related to the defect wherein the information is displayed in at least one of a text box, a list, and a drop-down box wherein the displaying information is a result of pointing to the component; and receiving input related to testing of the defect to update tracking information wherein the receiving uses at least one of the text box, the list, and the drop-down box.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which develops and tests software more efficiently through a computer program product stored on machine-readable media, the product including machine executable instructions for tracking a defect during development of a software work product, the computer program product including instructions for displaying the defect; identifying a component of the work product including the defect; displaying information related to the defect; and receiving input related to testing of the defect to update tracking information.

Further disclosed is a computer program product stored on machine-readable media, the product including machine executable instructions for incorporation into another application as supplemental program code and for tracking a defect during development of a software work product, the computer program product including instructions for displaying the defect in a listing; identifying a component of the work product including the defect by at least one of highlighting, font color changing, and flashing; displaying information related to the defect wherein the information is displayed in at least one of a text box, a list, and a drop-down box wherein the displaying information is a result of pointing to the component; and receiving input related to testing of the defect to update tracking information wherein the receiving uses at least one of the text box, the list, and the drop-down box.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a computer processing system;

FIG. 2 illustrates an exemplary embodiment of a display for testing software and tracking a defect and a fix; and

FIG. 3 presents an exemplary method for developing and testing software.

The detailed description explains the preferred embodiments of the invention, together with advantages and features, by way of example with reference to the drawings.

### DETAILED DESCRIPTION OF THE INVENTION

The teachings are based on an iterative process for software development. Generally, in the prior art, a software developer writes software and documents defects and associated fixes. A software tester tests the software using information related to the defects and the associated fixes documented by the software developer. The software tester documents if each fix was successfully tested. The software developer receives information related to the fixes that were not successfully tested. Using the information, the software developer provides another fix for the defect to complete one iteration of the process.

The teachings provide an integrated software application or framework for developing and testing a computer program. After the computer program is successfully tested, the computer program may be removed from the application for distribution to a user. Using the application is discussed next.

A software developer will use the application to identify which components of the computer program had defects that were fixed. Additionally, the software developer will input into the application information related to each correction (or “fix”) in each component. A software tester will use the application to test the computer program. The application will provide to the software tester a list of defects. The list of defects is generally shown within a separate panel within the application. The application will also identify components that include corrections (or fixes) for the defects. The software tester can direct the application to display information related to each defect in the components. The software tester can also input into the application a determination as to whether a fix was successfully tested or not. Before the teachings are discussed in detail, certain definitions are provided.

The term “application” relates to a software product for providing the teachings herein. The application includes machine executable instructions stored on machine readable media for developing a work product. The term “component” relates to a section of work product written to a specification. The component is generally interchangeable with other sections of the work product written to the same specification. The term “fix” relates to a defect in the work product that has been corrected. In general, the fix is successful if the defect has been addressed. The term “work product” refers to software subject to testing with the application.

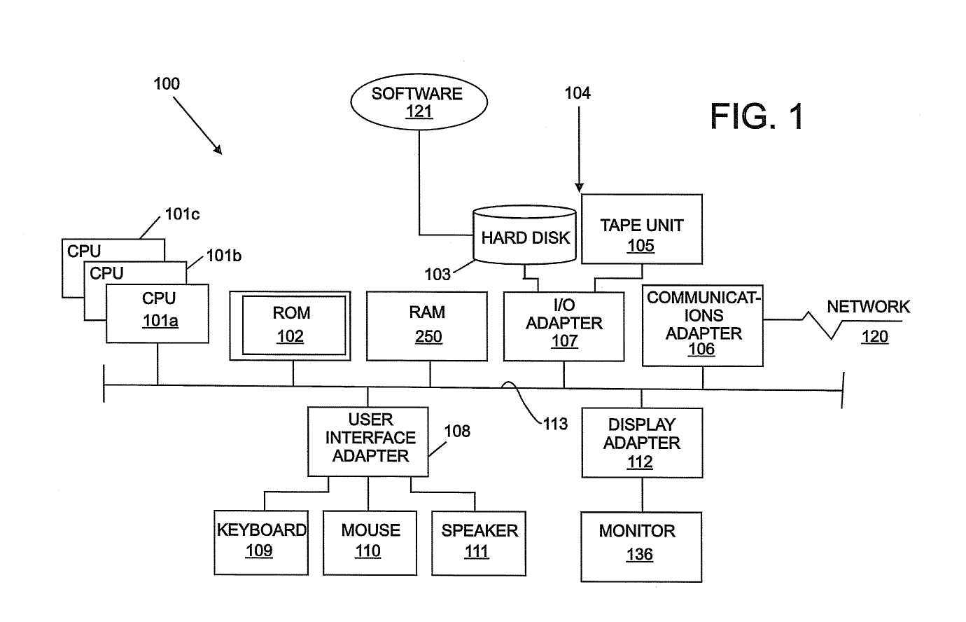

Referring now to FIG. 1, an embodiment of a computer processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. The network adapter 106 interconnects bus 113 with a network 122 enabling data processing system 100 to communicate with other such systems. The network 122 can be a local-area network (LAN), a metro-area network (MAN), or wide-area network (WAN), such as the Internet or World Wide Web. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters generally include common protocols, such as the Peripheral Components Interface (PCI). Additional input/output devices are shown as connected to system bus 113 via user interface adapter 108 and display adapter 112. An operator keyboard 109, mouse 110, and speaker 111 all interconnected to bus 113 via user interface adapter 108, which may include, for example, a Super I/O chip integrating multiple device adapters into a single integrated circuit. Test keyboards 114a, 114b, 114c, etc. (collectively or generically referred to as test keyboard(s) 114) are connected to the user interface adapter 108. Typically, the system 100 is controlled via the operator keyboard 109 and mouse 110.

As disclosed herein, the system 100 includes machine readable instructions stored on machine readable media (for example, the hard disk 103) for developing and testing a work product. As disclosed herein, the instructions are referred to as “application 121.” The application 121 may be produced using software development tools as are known in the art. The application 121 may be provided as an “add-in” to another application (where “add-in” is taken to mean supplemental program code as is known in the art). In such embodiments, the application 121 replaces or supplements structures of the application for developing and testing the work product.

Thus, as configured FIG. 1, the system 100 includes processing means in the form of processors 101, storage means including system memory 250 and mass storage 104, input means such as the operator keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

It will be appreciated that the system 100 can be any suitable computer, Windows-based terminal, wireless device, information appliance, RISC Power PC, X-device, workstation, mini-computer, mainframe computer, cell phone, personal digital assistant (PDA) or other computing device.

Examples of other operating systems supported by the system 100 include versions of Windows, Macintosh, LINUX, and UNIX, or other suitable operating systems.

Users of the system 100 can connect to the network 122 through any suitable connection, such as standard telephone lines, digital subscriber line, LAN or WAN links (e.g., T1, T3), broadband connections (Frame Relay, ATM), and wireless connections (e.g., 802.11(a), 802.11(b), 802.11(g)). Using the application 121 is discussed next.

In an exemplary embodiment, the application 121 receives input from the software developer concerning components that have at least one fix. The input may include how each fix was implemented. When the software tester opens the application 121, the software tester is presented with a list of defects that were fixed. As the software tester tests the work product according to a test plan, components that contain fixes are identified. The components may be identified by highlighting of component information.

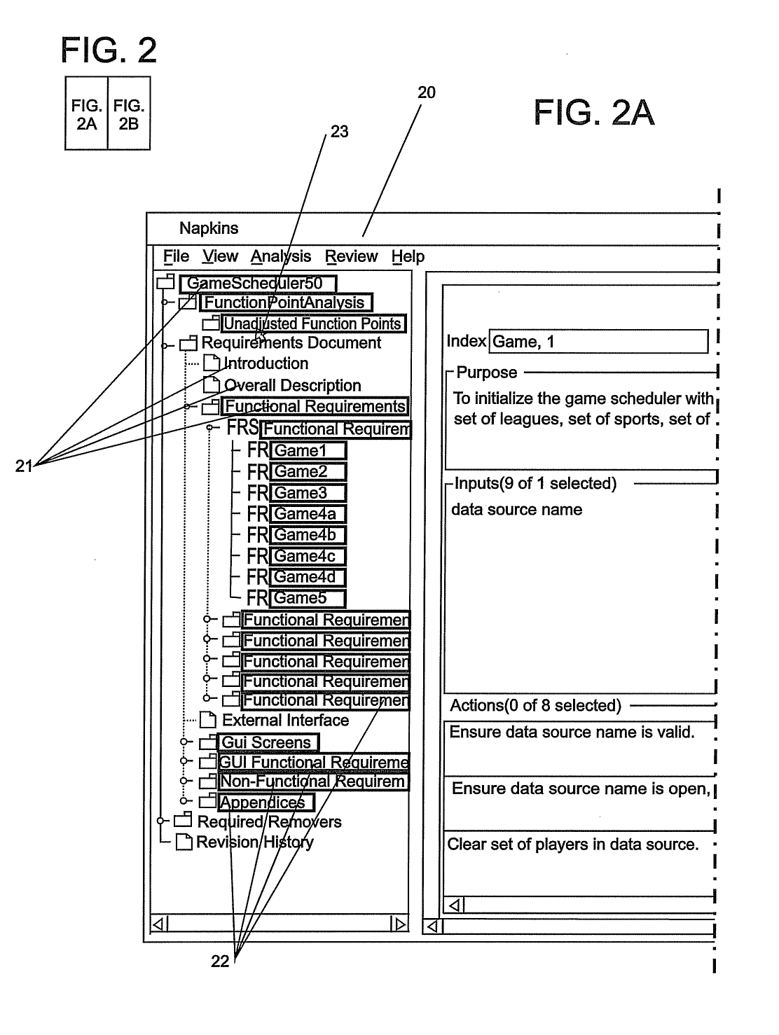

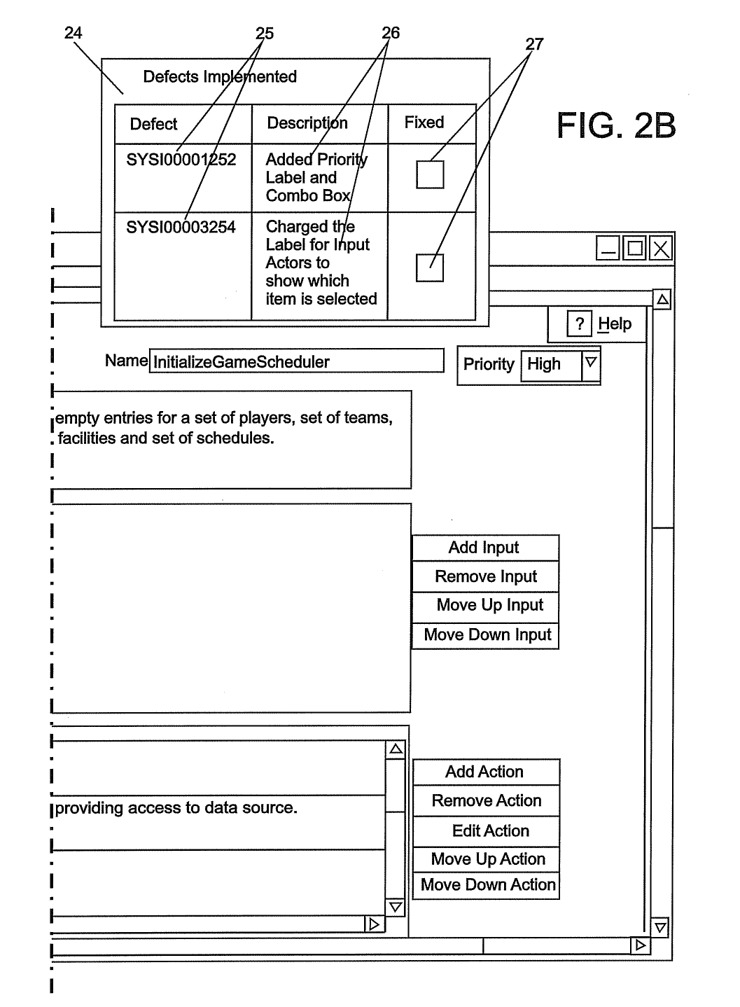

FIG. 2 illustrates an exemplary embodiment of a display 20 presented to the software tester. The display 20 includes a list of components 21 that are being tested. The display 20 also includes highlighting 22. The highlighting 22 highlights any component 21 that includes a defect that was fixed. In other embodiments, the components 21 including fixes may be identified by at least one of changing a font color and flashing. The software tester can request detailed information related to the fixes in each of the components 21. As an example, the software tester can place a pointer 23 over a highlighted component to request the detailed information. Upon receiving a request, the application 121 will display the detailed information. In one embodiment, the detailed information is displayed in a text box 24. In other embodiments, the detailed information may be displayed in one of a list and a drop-down box.

The test box 24 may include a defect identification 25, a defect description 26 and an input box 27 for receiving input as to whether a defect identified by the defect identification 25 was successfully addressed. Additionally, the text box 24 can receive input for entering a newly identified defect. The input is generally used by the next person (i.e., the software developer or the software tester) in the iterative process.

As an example, the application 121 may be implemented using the Java programming language. Within the application 121, a separate jar file may be created. This jar file would create separate Testing Components for all graphical-user-interface (GUI) components 21. For example, the equivalent Testing Component for JTable may be called JTableTesting, which would extend JTable. JTableTesting can receive a Boolean value that may be used in the application 121. If the Boolean value represented true, a defect was fixed within the GUI component 21. The application 121 may also receive a String describing the fix for the defect. When the software tester completed testing the fixes, a batch job may be run against all of the GUI components 21 within the computer program being tested. The fixes that are verified as being successfully tested will incorporate the GUI component that was successfully tested. For example, the JTableTesting would remove the Boolean value and the String value of the description of the problem. If any new defects were found, the software tester will have to specify the GUI component 21 and update the work product. The batch job can then take an equivalent component 21 to where the defect was found and create an equivalent testing constructor.

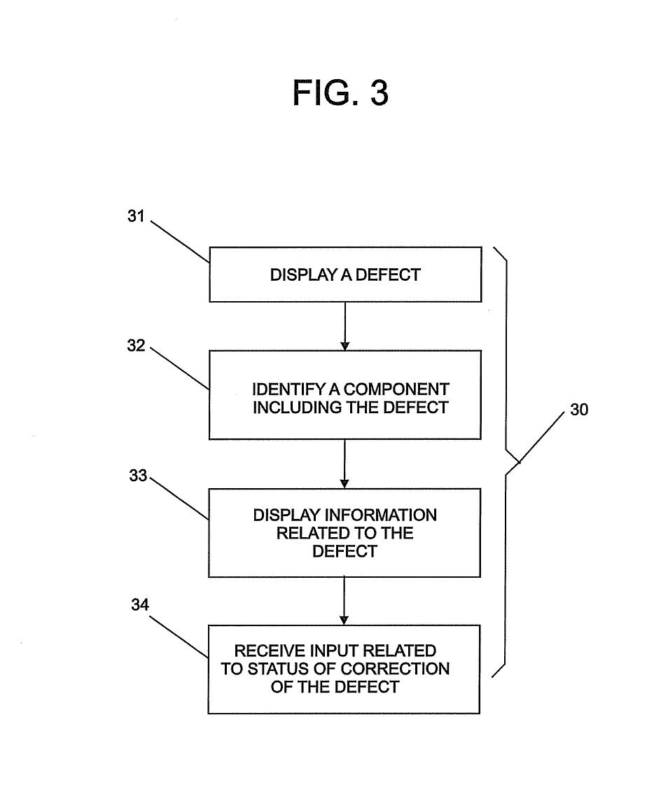

FIG. 3 presents an exemplary method 30 for developing and testing the work product. The method 30 calls for displaying 31 a defect. Further, the method 30 calls for identifying 32 the component 21 including the defect. Further, the method 30 calls for displaying 33 information related to the defect. Further, the method 30 calls for receiving 34 input related to status of correction of the defect. In general, the input is used to update tacking information. The input is generally used in a following step of the iterative process.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine-readable media, the product comprising machine executable instructions for tracking a defect during development of a software work product, the computer program product comprising instructions for:
displaying the defect;
identifying a component of the work product comprising the defect;
displaying information related to the defect; and
receiving input related to testing of the defect to update tracking information.

2. The computer program product as in claim 1, wherein displaying the defect comprises displaying a listing of defects.

3. The computer program product as in claim 1, wherein the information comprises changes to computer code of the work product.

4. The computer program product as in claim 1, wherein the information is displayed in at least one of a text box, a list and a drop-down box.

5. The computer program product as in claim 4, wherein the text box is adapted to receive the input.

6. The computer program product as in claim 1, wherein identifying comprises at least one of highlighting, font color changing and flashing.

7. The computer program product as in claim 1, wherein the displaying information occurs after pointing to the component.

8. The computer program product as in claim 1, wherein the product comprises supplemental program code.

9. The computer program product as in claim 1, the computer program product comprising Java programming language.

10. A computer program product stored on machine-readable media, the product comprising machine executable instructions for incorporation into another application as supplemental program code and for tracking a defect during development of a software work product, the computer program product comprising instructions for:
displaying the defect in a listing;
identifying a component of the work product comprising the defect by at least one of highlighting, font color changing, and flashing;
displaying information related to the defect wherein the information is displayed in at least one of a text box, a list, and a drop-down box wherein the displaying information is a result of pointing to the component; and
receiving input related to testing of the defect wherein the receiving uses at least one of the text box, the list, and the drop-down box.
